(19) United States
(12) Patent Application Publication
(10) Pub. No.: US 2012/0290264 A1
(43) Pub. Date: Nov. 15, 2012

(54) METHOD AND APPARATUS FOR DYNAMICALLY ADJUSTING DATA ACQUISITION RATE IN AN APM SYSTEM

(75) Inventors: John Monk, Larkspur, CO (US); Dan Prescott, Elbert, CO (US); Robert Vogt, Colorado Springs, CO (US); Bruce Kosbab, Colorado Springs, CO (US); Shawn McManus, Colorado Springs, CO (US); Doug Roberts, McDonough, GA (US); Michael Upham, Colorado Springs, CO (US)

(73) Assignee: FLUKE CORPORATION, Everett, WA (US)

(21) Appl. No.: 13/106,832

(22) Filed: May 12, 2011

(51) Int. Cl. G06F 11/30

(52) U.S. Cl. 702/186

(57) ABSTRACT

Data acquisition rates are dynamically adjusted in an APM system, by monitoring data acquisition hardware and reducing the data acquisition rate when a determination is made that the data rate is too high for processing by an APM.

### BACKGROUND OF THE INVENTION

This invention relates to networking, and more particularly to adjusting data acquisition rates in an application performance management (APM) system.

Application performance management (APM) uses monitoring and/or troubleshooting tools for observation of network traffic and for application and network optimization and maintenance. The current state of the art in most application performance management systems employs multi-threaded, pipelined collections of acquisition, real time analysis and storage elements. These APM systems are subject to the simple rule that they can only analyze data up to a finite data rate, past which point they fail to function or must fundamentally shift their operation (for example, relegating analysis in favor of storage).

In high traffic networks, data volume can lead to oversubscription, the condition where the incoming data rate is too high for network monitoring systems to process. One way this problem manifests itself is in terms of analysis latency. There is software latency in all application specific application analyzers (applications such as: Http, Oracle, Citrix, TCP, etc). When it attempts to analyze too much data, the aggregate latency across various discrete portions of a monitoring system puts enough collective drag on the overall system that it becomes difficult to keep up with processing and analyzing the incoming data. It is computationally impractical to perform full analysis in real time of every packet/flow/conversation on a highly utilized computer network.

Another manifestation of this problem is output latency. In some cases while analysis systems can keep up with incoming traffic from an analysis point of view, due to the volume of data that is being written to disk (transactions, packets, statistics, etc), the disk writes take long enough that “back pressure” is exerted upstream onto analysis which eventually slows down analysis to the point where the analysis can no longer keep up with incoming traffic. In a multithreaded, decoupled system the “back pressure” is the competition for CPU bandwidth between, for example, a DBMS and APM analysis software. During periods of sustained DBMS writes, the DBMS engine necessarily uses more of the total CPU “budget”, thereby leaving less CPU time for analysis.

### SUMMARY OF THE INVENTION

An object of the invention is to provide for dynamically adjusting data acquisition rate in an APM system, by monitoring data acquisition hardware and reducing the data acquisition rate when a determination is made that the data rate is too high for processing by downstream analysis processes.

Accordingly, it is another object of the present invention to provide an improved APM system that dynamically adjust the data acquisition rate.

It is a further object of the present invention to provide an improved network monitoring system that adjusts data acquisition rates dynamically to avoid analysis errors from oversubscription.

It is yet another object of the present invention to provide improved methods of network monitoring and analysis that enable dynamic adjustment of data acquisition rates.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of a network with a network analysis product interfaced therewith;

FIG. 2 is a block diagram of a monitor device for dynamically adjusting data acquisition rates; and

FIG. 3 is a diagram illustrating the operation of the apparatus and method for dynamically adjusting data acquisition rates.

### DETAILED DESCRIPTION

The system according to a preferred embodiment of the present invention comprises a monitoring system and method and an analysis system and method for dynamically adjusting data acquisition rates in an APM system.

The invention monitors the incoming network traffic acquisition rates, determining the amount of time that the system can continue to operate without dropping incoming packets, called time to failure (TTF). If the TTF value drops below a certain threshold, the amount of traffic sent on to the analysis process will be decreased. This process of computing the TTF value and reacting is repeated until the system reaches a stable state where the current rate of analyzed network traffic can be maintained indefinitely without the system dropping incoming packets. Conversely, if the system detects that it is running under its maximum capacity and not all of the traffic is being sent on for analysis, the system will increase the amount of traffic being analyzed and reassess the stability of the system.

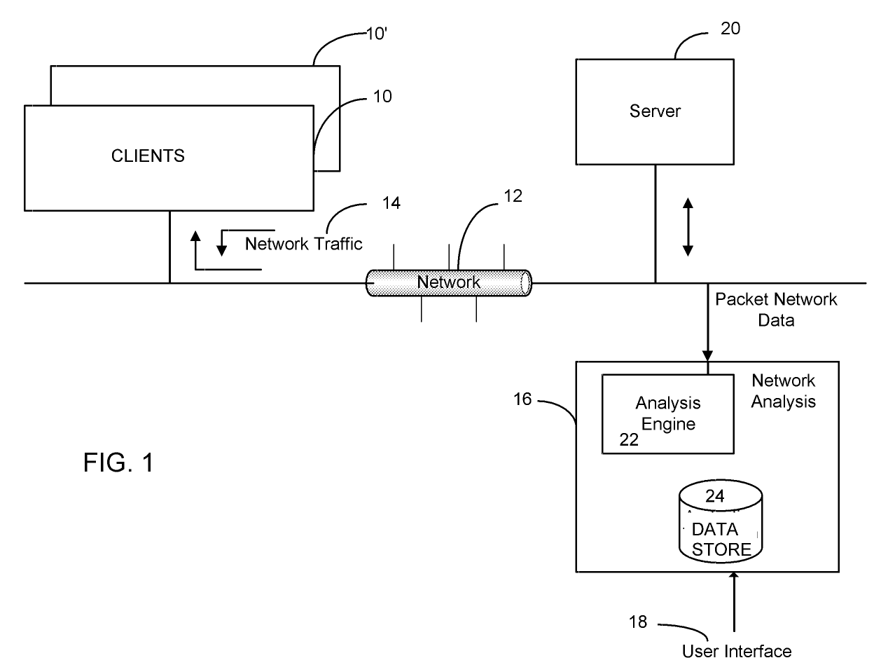

Referring to FIG. 1, a block diagram of a network with an apparatus in accordance with the disclosure herein, a network may comprise plural network clients 10, 10′, etc., which communicate over a network 12 by sending and receiving network traffic 14 via interaction with server 20. The traffic may be sent in packet form, with varying protocols and formatting thereof.

A network analysis device 16 is also connected to the network, and may include a user interface 18 that enables a user to interact with the network analysis device to operate the analysis device and obtain data therefrom, whether at the location of installation or remotely from the physical location of the analysis product network attachment.

The network analysis device comprises hardware and software, CPU, memory, interfaces and the like to operate to connect to and monitor traffic on the network, as well as performing various testing and measurement operations, transmitting and receiving data and the like. When remote, the network analysis device typically is operated by running on a computer or workstation interfaced with the network. One or more monitoring devices may be operating at various locations on the network, providing measurement data at the various locations, which may be forwarded and/or stored for analysis.

The analysis device comprises an analysis engine 22 which receives the packet network data and interfaces with data store 24.

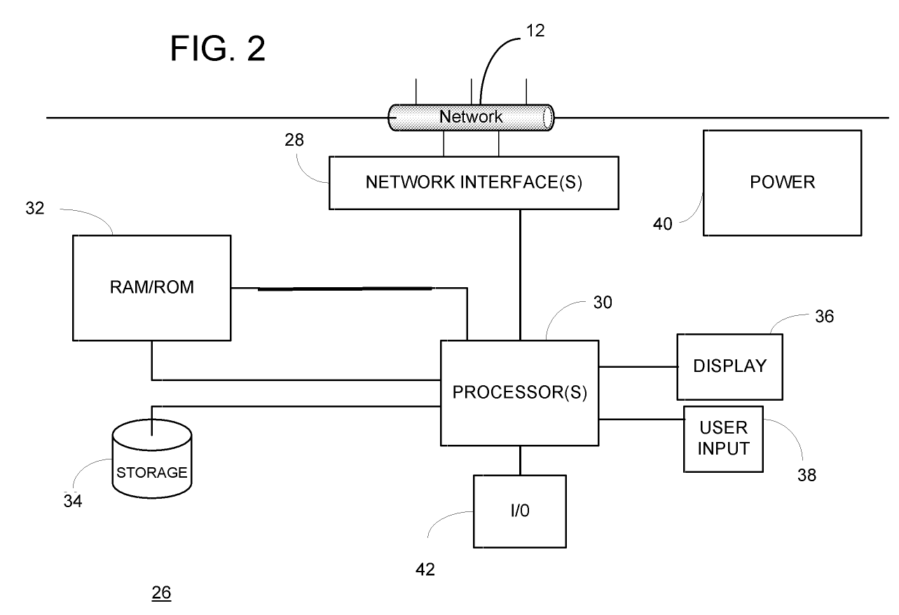

FIG. 2 is a block diagram of a test instrument/analyzer 26 via which the invention can be implemented, wherein the instrument may include network interfaces 28 which attach the device to a network 12 via multiple ports, one or more processors 30 for operating the instrument, memory such as RAM/ROM 32 or persistent storage 34, display 36, user input devices (such as, for example, keyboard, mouse or other pointing devices, touch screen, etc.), power supply 40 which may include battery or AC power supplies, other interface 42 which attaches the device to a network or other external devices (storage, other computer, etc.).

In operation, the network test instrument is attached to the network, and observes transmissions on the network to collect data and analyze and produce statistics thereon. In a particular embodiment, the instrument monitors the memory buffer into which the acquisition hardware writes packets, to determine whether or not downstream analysis is able to keep up with the rate at which data is written.

A performance manager agent continually monitors the hardware packet buffer (fill rate/drain rate) ratio, and passes this information to a downstream agent (the Traffic Attenuator) that decides whether or not to include/exclude more conversations as appropriate. This inclusion/exclusion provides an extensible way to scale the quantity of data that is to be analyzed, called dynamic scaling.

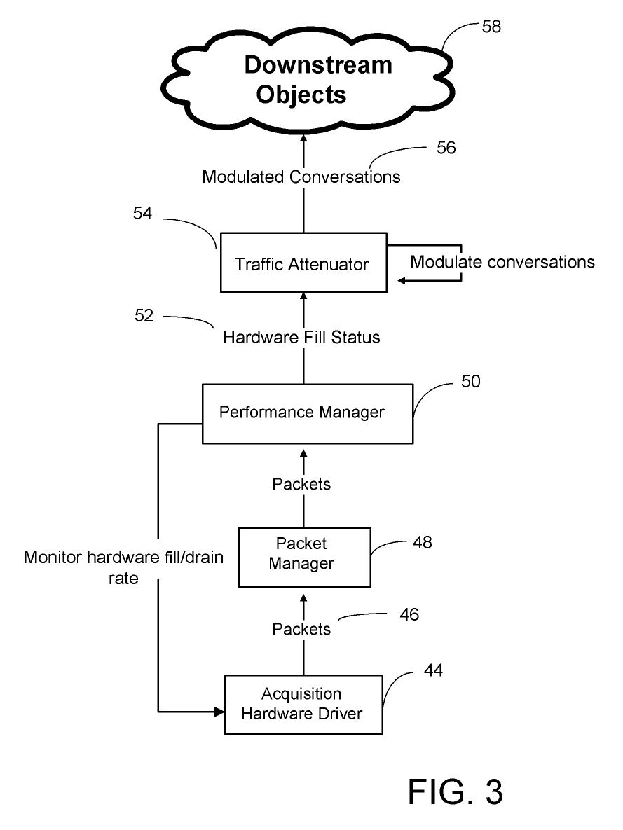

Referring to FIG. 3, a diagram illustrating the operation of the apparatus and method for dynamically adjusting data acquisition rates, an acquisition hardware driver 44 supplies acquired packets 46 to a packet manager 48 which takes the raw packets and prepares them for processing downstream.

Packets 46 are supplied to a performance manager 50, which monitors the fill/drain rate of the acquisition hardware, and supplies packets and a hardware fill status indication 52 to traffic attenuator 54. Traffic attenuator 54 performs conversation modulation depending on the hardware fill status, and supplies modulated conversations 56 to downstream objects 58 for further processing an analysis.

In order to scale back the data that is analyzed, the incoming data is sampled at the “conversation” level, rather than the flow or packet level. The conversation level means, for example, a series of data exchanges between two IP addresses with a given protocol type. Since some data is excluded from detailed analysis when scaling takes place, in order to maintain some meaning to the data analysis, flows/packets that are excluded from analysis are accounted for by determining packet count/byte count characteristics of the particular metrics that is of interest (for example, transactions) with respect to a given criteria (for example, application (as defined by port), IP addresses), using the flows that get fully analyzed as the source of empirical observations. Then the desired metric is inferred using the counts of the excluded traffic. While this results in some limitations on the data analysis, such as reduced accuracy, or limitation on flexibility of sorting criteria, this approach does allow determination of transient phenomena, such as spikes in traffic.

The performance manager 50 is suitably implemented as a software agent that continually monitors the hardware packet buffer (fill rate/drain rate) ratio, while the traffic attenuator 54 is implemented as a software agent that decides whether or not to include/exclude more conversations as appropriate.

The attenuation may be accomplished by reference to attenuation schedules, multiple such schedules being possible. In a particular embodiment, a general attenuation schedule is provided for normal operation and an aggressive attenuation schedule is provided for situations where the hardware monitoring determines that the general attenuation schedule is not sufficiently keeping up. The schedules provide a percentage value of conversations that are to be attenuated, whereby the conversations that are attenuated are not passed on for further analysis by downstream objects.

Example attenuation schedules are:

General Attenuation Schedule

| | attenuate this % of |
|---|---|
| hardware fill ‘level’ | conversations |
| 0% | attenuation = 0 |
| 10% | attenuation = 0 |
| 20% | attenuation = 0 |
| 30% | attenuation = 20 |
| 40% | attenuation = 30 |
| 50% | attenuation = 40 |
| 60% | attenuation = 50 |
| 70% | attenuation = 60 |
| 80% | attenuation = 70 |
| 90% | attenuation = 80 |
| 100% | attenuation = 80 |

Aggressive Attenuation Schedule

| | attenuate this % of |
|---|---|
| hardware fill ‘level’ | conversations |
| 0% | attenuation = 0 |
| 10% | attenuation = 0 |
| 20% | attenuation = 20 |
| 30% | attenuation = 30 |
| 40% | attenuation = 40 |
| 50% | attenuation = 50 |
| 60% | attenuation = 60 |
| 70% | attenuation = 70 |
| 80% | attenuation = 80 |
| 90% | attenuation = 90 |
| 100% | attenuation = 90 |

Accordingly, the invention provides dynamic adjustment of data acquisition rates in an APM system to avoid oversubscription, while still providing data for downstream analysis and inference of discarded data. The system, method and apparatus dynamically adjust the rate of incoming network data when the data rates present exceed the capacity of the system to fully analyze them, solving the problem of allowing excessive network data to overwhelm an application performance monitoring system.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method of dynamically adjusting a data acquisition rate for an application performance management system, comprising:
monitoring a data storage hardware capacity fill/drain rate; and
attenuating conversations provided to downstream analysis based on the monitored fill/drain rate.

2. The method according to claim 1, wherein said attenuating comprises:
employing an attenuation schedule to determine when conversations should be provided or not provided to downstream analysis.

3. The method according to claim 1, wherein said attenuating comprises:
employing plural attenuation schedules to determine when conversations should be provided or not provided to downstream analysis, said schedules chosen based on the fill/drain rate.

4. A system for dynamically adjusting a data acquisition rate for an application performance management system, comprising:
a data storage hardware capacity fill/drain rate monitor; and
a traffic attenuator receiving a fill/drain rate value from said monitor, said attenuator attenuating conversations provided for downstream analysis based on the monitored fill/drain rate.

5. The system according to claim 4, wherein said traffic attenuator comprises:
an attenuation schedule to determine when conversations should be provided or not provided for downstream analysis.

6. The system according to claim 4, wherein said traffic attenuator comprises:
plural attenuation schedules to determine when conversations should be provided or not provided for downstream analysis, said schedules chosen based on the fill/drain rate.

7. A network test instrument for dynamically adjusting a data acquisition rate for an application performance management system, comprising:
network data acquisition device including data storage;
a data storage capacity fill/drain rate monitor; and
a traffic attenuator receiving a fill/drain rate value from said monitor, said attenuator attenuating conversations provided for downstream analysis based on the monitored fill/drain rate.

8. The network test instrument according to claim 7, wherein said traffic attenuator comprises:
an attenuation schedule to determine when conversations should be provided or not provided for downstream analysis.

9. The network test instrument according to claim 7, wherein said traffic attenuator comprises:
plural attenuation schedules to determine when conversations should be provided or not provided for downstream analysis, said schedules chosen based on the fill/drain rate.
